(19) United States
(12) Patent Application Publication
(10) Pub. No.: US 2008/0259245 A1
(43) Pub. Date: Oct. 23, 2008

(54) BACKLIT DISPLAY

(76) Inventor: Samir Mezouari, Basildon (GB)

Correspondence Address: FRASER CLEMENS MARTIN & MILLER LLC, 28366 KENSINGTON LANE, PERRYSBURG, OH, 43551, US

(21) Appl. No.: 12/099,432

(22) Filed: Apr. 8, 2008

(30) Foreign Application Priority Data
Apr. 17, 2007 (GB) 0707475.0

(51) Int. Cl. G02F 1/13357

(52) U.S. Cl. 349/64

(57) ABSTRACT

The present invention relates to the field of the backlighting of displays. A backlit display unit comprises a display medium for displaying visible information to a user of the unit, an LED light source for backlighting the display medium, a light diffuser for diffusing light which is incident on the light diffuser, and a printed circuit board carrier which supports the light source. The light diffuser is spaced apart from the display medium and is in an intermediate orientation with respect to the light diffuser and the display medium. The carrier has opposite first and second surfaces, the first surface being oriented generally towards the display medium and the second surface being oriented generally towards the light diffuser. The surfaces are bounded by one or more edges. The arrangement is such that illumination from the light source is directed away from the display medium to be incident upon the light diffuser. This incident light is then diffused by the light diffuser past the edges of the printed circuit board back towards the display medium to provide backlight illumination for the display medium.

### CROSS-REFERENCE TO RELATED APPLICATION

This application claims the benefit of United Kingdom Patent Application No. 0707475.0 filed Apr. 17, 2007, hereby incorporated herein by reference in its entirety.

### FIELD OF THE INVENTION

The present invention relates to the field of the backlighting of displays.

### BACKGROUND OF THE INVENTION

Displays are often provided with backlighting, used to provide illumination through clear or translucent portions of components forming the display. Examples include liquid crystal display (LCD's), or indication displays having an applique with transparent or translucent portions through which the backlit illumination passes.

Examples in the field of automotive displays include LCD displays for displaying alphanumeric or graphical information, speedometer, or engine speed (rpm) displays having translucent numeric indications.

Traditionally, such displays have been illuminated with incandescent bulbs, although recently, there has been interest in using light emitting diodes (LEDs), particularly white LEDs, because of their compact size and long lifetime.

The display is usually part of a display module seated inside a dashboard assembly. The depth of the display module may be limited because of the space required behind the display for wiring or ducting, and in any event it is desirable to limit the depth of the display.

Display modules comprise normally a rigid or flexible printed circuit carrier, for example printed flex strip or a rigid printed circuit board (PCB) with conduction tracks and components on one or both sides. In order to provide even backlight illumination over an area of the display, it may be necessary to use two or more lights spaced across the display. When incandescent bulbs are used, use of multiple bulbs may also be desirable to facilitate overlap of the illumination provided by the bulbs so that when one bulb fails, a portion of the display does not go completely dark.

White LED's are considerably more expensive than incandescent bulbs, so in almost all cases it is uneconomic simply to replace each incandescent light with an LED. The manufacturing process of white LED's also leads to some inevitable hue variation in the shade of white produced by the different LED's. This can lead to unpredictable color variations across a backlit display.

Therefore, the use of LED's in backlit display applications has in practice been limited to small area displays both for reasons of cost and for color uniformity.

It would be desirable to provide a more convenient backlit display, which addresses these limitations.

### SUMMARY OF THE INVENTION

According to the invention, there is provided a backlit display unit, comprising, a display medium for displaying information to a user of the unit, a light source for backlighting the display medium, a light diffuser for diffusing light incident thereon and a carrier, the carrier supporting the light source, wherein:
1. the light diffuser is spaced apart from the display medium;
2. the carrier is substantially in an intermediate orientation with respect to the light diffuser and the display medium;
3. the carrier has opposite first and second surfaces, the surfaces being bounded by one or more edges; and
4. the arrangement is such that illumination from the light source is directed away from the display medium to be incident upon the light diffuser, and the incident light is diffused by the light diffuser past the edge(s) back towards the display medium to provide backlight illumination for the display medium.

Also according to the invention, there is provided a method of providing diffuse backlit illumination to a display unit, the display unit comprising a display, a light source, a light diffuser spaced apart from the display medium, and a carrier substantially in an intermediate orientation with respect to the light diffuser and the display medium, the carrier supporting the light source and having opposite first and second surfaces, the surfaces being bounded by one or more edges, wherein the method comprises the steps of:
1. using the light source to generate light;
2. directed the light away from the display medium to be incident upon the light diffuser;
3. using the light diffuser to diffuse the incident light and to direct at least a portion of the diffused light back towards the display medium and past the edge(s); and
4. using the diffused light to backlight the display medium to display eye visible information to a user of the unit.

The invention also provides a display assembly comprising a backlit display unit and a rear cover, in which the backlit display unit and at least a portion of the light diffuser is provided by the rear cover.

The light source may be any type of light source suitable for back illumination of a display, but preferably includes at least one solid state light emitter.

The displayed information may be any type of information for a user of the unit, for example alphanumeric information, a gauge or dial markings, graphical symbols or warning indicators.

The carrier may include conductors for conveying electrical current to the light source.

The carrier may be any suitable type of carrier, but is preferably a printed circuit carrier, for example a flexible printed circuit strip, or moulded printed circuit board. In one embodiment of the invention, the carrier is a glass-fiber printed circuit board.

In another embodiment of the invention, the light source is a solid state light source. This could be a visible laser diode but is typically at least one LED, for example colored LEDs grouped together to form a white LED or to achieve a user-defined color.

In another embodiment of the invention, a single white LED is positioned centrally with respect to the display medium. The use of a single white LED avoids problems with color matching of multiple white LEDs and also helps to minimize manufacturing costs as opposed to a display having multiple white LEDs.

The light source may be supported by the carrier adjacent an edge to the surfaces. In the embodiments of the invention, the arrangement is such that the display medium is either fully offset with respect to the first surface so that the edge does not cast a noticeable shadow on the display medium, or the carrier is not sufficiently wide to cast a noticeable shadow on the display medium. To this end, the optical distance between the carrier and the diffuser plus the optical distance from the diffuser to the carrier and then from the carrier to the display medium may be selected to provide substantially uniform backlit illumination.

The carrier may be a substantially planar carrier, the display medium includes a substantially planar display surface, with the carrier parallel with the display surface.

When the carrier is a substantially planar carrier, the light diffuser may include a substantially planar diffusing surface, with the carrier parallel with the diffusing surface.

The edge or edges of the carrier may be shaped to define at least one aperture to facilitate diffused light passing therethrough to provide back illumination for the display medium.

The carrier may extend either partially or fully around the aperture.

The aperture may be rectangular, square, circular, in the shape of a partial annulus, or any other shape depending on the shape of the display medium.

### BRIEF DESCRIPTION OF THE DRAWINGS

The invention will now be further described, by way of example only, and with reference to the accompanying drawings, in which:

FIG. 1 shows a front elevational view of a vehicular dashboard display assembly including a number of display units according to an embodiment of the invention, the display units include one alphanumeric rectangular liquid crystal display and one major dial and pointer display;

FIG. 2 is an exploded perspective schematic representation of a rectangular liquid crystal display, showing a display unit according to an embodiment of the invention;

FIG. 3 is a cross-section view through the liquid crystal display, taken along line III-III of FIG. 2;

FIG. 4 is a schematic cross-section through a dial and pointer display, showing a display unit according to another embodiment of the invention;

FIG. 5 is a schematic cross-section similar to that of FIG. 4, showing a display unit according to another embodiment of the invention;

FIGS. 6 and 7 are exploded perspective schematic representations of the components of the display units of FIGS. 4 and 5; and

FIG. 8 is a schematic cross-section through a dial and pointer display, showing a display unit according to another embodiment of the invention.

### DETAILED DESCRIPTION OF THE EMBODIMENTS

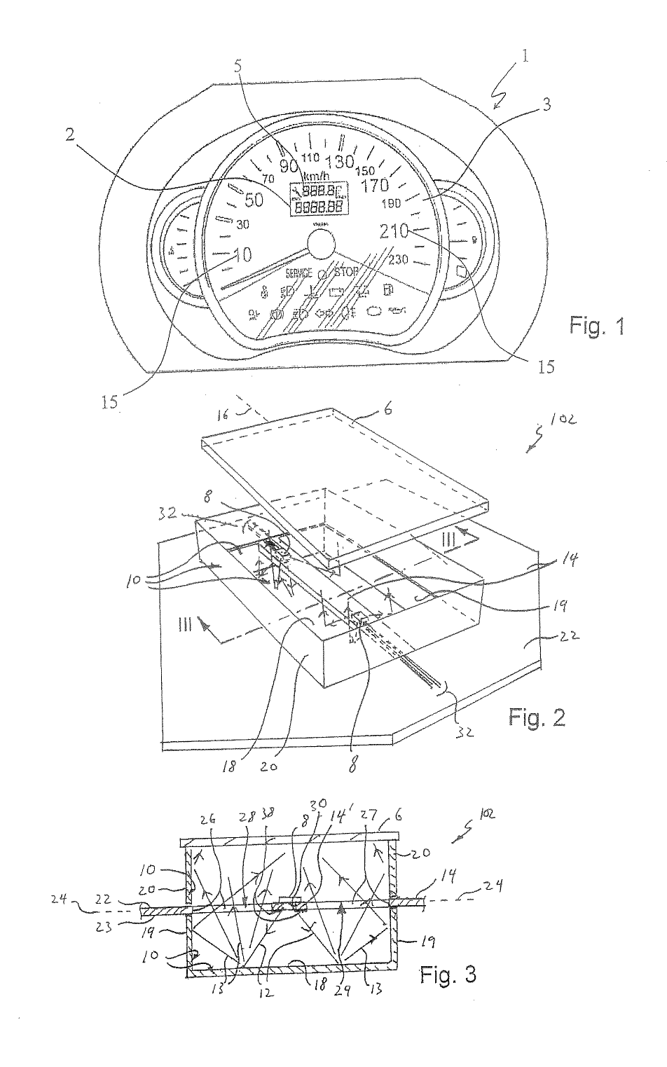

With reference first to FIG. 1, a vehicular dashboard display assembly 1, comprises a number of display units, including one alphanumeric rectangular liquid crystal display (LCD) 2 and one major dial and pointer display 3. The liquid crystal and dial displays 2, 3 are each backlit so that a user can see alphanumeric or graphical information 5 on the LCD or numerical indicia 15 on the dial display.

FIGS. 2 and 3 show schematically a rectangular liquid crystal display unit 102, according to a first embodiment of the invention. The unit comprises a display medium 6 for displaying visible information to a user of the unit, an LED light source 8 for backlighting the display medium 6, a light diffuser 10 for diffusing light 12 which is incident on the diffuser 10, and a printed circuit board (PCB) carrier 14 which supports the light source 8. The diffuser 10 is formed from a white plastic material.

The light source 8 is provided by two white LEDs mounted on a bar or bridge section 14′ of the PCB carrier 14. The LCD 6 is rectangular, and the PCB bridge 14′ extends in a direction aligned with a long axis 16 of the LCD.

The PCB carrier 14 is spaced apart from the display medium 6 and is substantially in an intermediate orientation with respect to the light diffuser 10 and the display medium 6.

The light diffuser 10 is an “open box” type light diffuser, having a rectangular base 18, and four side walls that extends perpendicularly upwards from the base towards the display medium. Each side wall has a lower portion 19 and an upper portion 20 divided by the PCB carrier 14 which extends in a plane parallel with and intermediate between planes defined by the extent of the LCD 6 and the diffuser base 18. The use of the upper portions 20 of the light diffuser 10 is optional. The base 18 (and optionally parts of the lower wall portion 19) provide primary diffusing of incident light 12, which is then scattered as indicated by arrows 13 to be incident on higher portions of the walls 19, 20. The upper wall portions 20 therefore provide a secondary diffusing of light. Thus, a majority or all of the light 12 from the light source 8 is incident on the diffuser base 18.

The PCB carrier 14 has opposite first and second surfaces 22, 23, the first surface 22 being oriented generally towards the display medium 6 and the second surface 23 being oriented generally towards the base 18 of the light diffuser 10. The first and second surfaces 22, 23 therefore define a plane 24 that extends between the light diffuser base 18 and the display medium 6.

The PCB surfaces 22, 23 are bounded by inner edges 26, 27 each in the form of a rectangle that form a pair of adjacent apertures 28, 29. The apertures 28, 29 are separated by the bridge 14′ of the PCB carrier 14 on which the light source 8 is supported, with the light source 8 being positioned next to these edges 26, 27.

The plane 24 of the PCB carrier 14 is parallel with the liquid crystal display medium 6, and the carrier 14 is positioned substantially equidistant from the light diffuser base 18 and the LCD 6. The reason for this is to maximize the uniformity of the diffuse illumination on the LCD 6. The light source 8 is supported directly adjacent each of the edges 26, 27 defining the PCB bridge 14′ . The arrangement is such that illumination 12 from the light source 8 is initially directed away from the display medium 6 to be incident upon the base 18 of the light diffuser 10. This incident light 12 is then diffused as indicated by arrows 13 by the light diffuser 10 through the apertures 28, 29 and past the edges 26, 27 of the PCB carrier 14 and bridge 14′ back towards the display medium 6 to provide backlight illumination. By positioning the PCB bridge 14′ mid-way between the diffuser base 18 and LCD 6, the shadow cast by the PCB bridge 14′ is minimized.

In this example, the light source 8 is supported on the first PCB surface 22. The PCB carrier 14 is therefore shaped or perforated 30 to permit light emitted by the light source 8 to be directed towards the light diffuser base 18.

The PCB carrier 14 includes on the first surface 22 conductive tracks 32 to convey electrical power to the light source 8. An advantage of this arrangement is that the PCB carrier 14 need only be single-sided, as other display components, connectors or circuitry can be provided on the side of the PCB carrier 14 nearest the front of the display assembly 1. A further advantage is that the second surface 23 of the PCB bridge 14′ may be painted white 38 without interfering with any conductive tracks to aid scattering of light within the diffuser 10.

The light source 8 may, however, alternatively, be positioned on the second surface 23, in which case the carrier may include on the second surface 23 conductive tracks to convey electrical power to the light source 8.

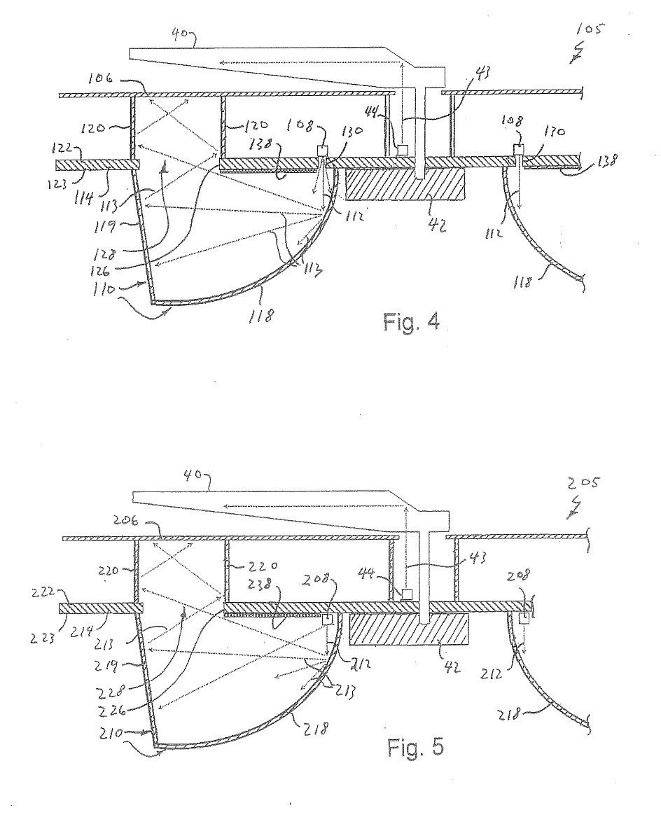

FIG. 4 is a schematic cross-section through a dial and pointer display, showing a display unit 105 according to another embodiment of the invention, in which features corresponding with those of FIG. 1 are indicated by reference numerals incremented by 100. In this example, the light source 108 is a plurality of white LED's arranged around an inner circumference of a dial display medium 106. The light source 108 is positioned on the first PCB surface 122, in which case the carrier 114 may include on the first surface 122 conductive tracks (not shown) to convey electrical power to the light source 108.

The PCB carrier 114 has a hole or cut-away 130 to permit light 112 from the light source 108 to shine through the PCB carrier 114 towards the light diffuser concave base 118.

The diffuser has a concave base 118 formed from a white plastic material, which scatters incident light 112 towards an aperture 128 defined by the edges 126 of an annular cut-out in the PCB carrier 114 that extends over an arc of about 270°.

Some light 112 may also be directly incident on a lowermost portion of the lower side wall 119. The arrangement directs scattered light as indicated by arrows 113 through the aperture 128. Optionally, further scattering occurs at an optional pair of radially inner and outer upper side walls 120 to provide backlight illumination of indicia on the display medium 106, for example, vehicular speed or engine speed. Optionally, the second surface 123 may be painted white 138 to aid scattering of light within the light box diffuser 110.

A central rotational dial pointer 40 is driven by a motor 42 mounted on the same PCB carrier 114. The dial receives light 43 from a separate light source 44 mounted on the first side 122 of the PCB carrier 114.

FIG. 5 is a schematic cross-section through a dial and pointer display, showing a display unit 205 according to another embodiment of the invention, in which features corresponding with those of FIG. 4 are indicated by reference numerals incremented by 100. This embodiment 205 differs from the embodiment 105 in that the light source 208 is positioned on the second PCB surface 223, in which case the carrier 214 may include on the second surface 223 conductive tracks (not shown) to convey electrical power to the light source 208.

Optionally, the second surface 223 may be painted white 238 to aid scattering of light within the light box diffuser 210.

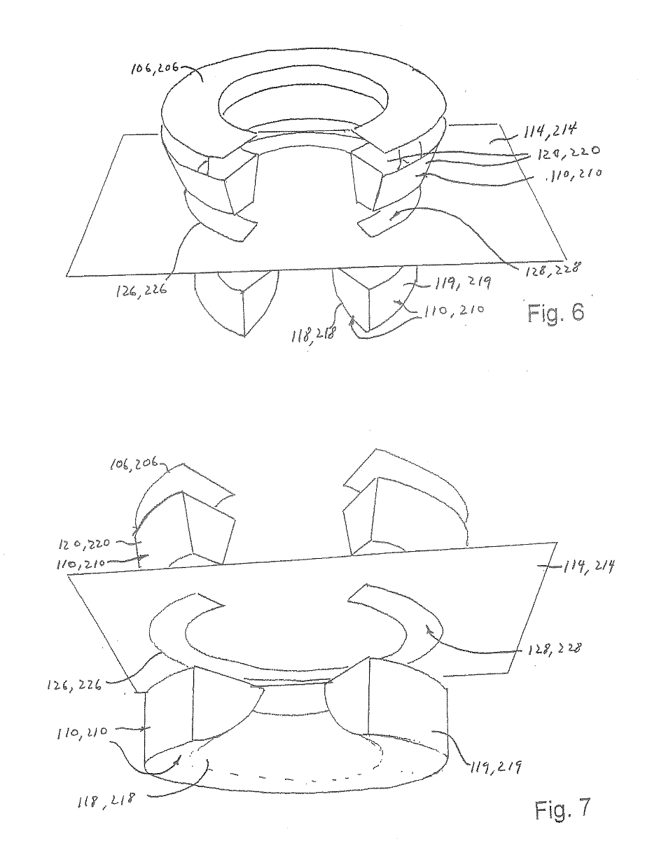

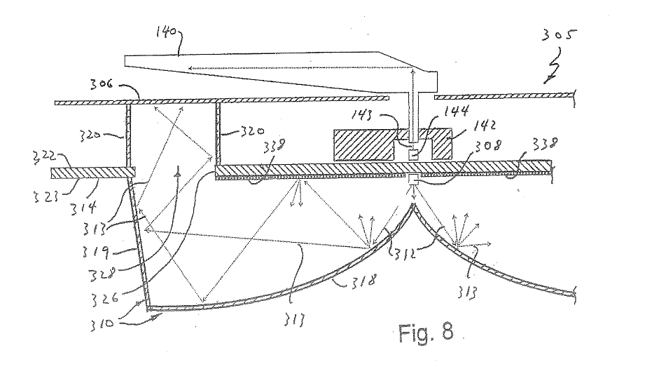

For the sake of clarity, FIGS. 6 and 7 show exploded perspective schematic representations of the main common components of the display units of FIGS. 4 and 5, namely the PCB carrier 114, 214, the diffuser 110, 210, and the display medium 106, 206.

FIG. 8 is a schematic cross-section through a dial and pointer display, showing a display unit according to another embodiment 305 of the invention, in which features corresponding with those of FIG. 5 are indicated by reference numerals incremented by 100. This embodiment differs from those above by having a single LED 308 centrally positioned with respect to the display medium 306. The light box diffuser 310 is open fully to the centre, and is circularly symmetric over the arc of the display medium so that that incident illumination 312 is directed evenly around the circumference of the display medium 306.

To make space for the central LED 308, the LED 308 is positioned on the second side of the POB carrier 314, while the pointer LED 144 is positioned on the first side 322.

Optionally, the second surface 323 may be painted white 338 to aid scattering of light 312 within the light box diffuser 310.

In all the embodiments described above, the PCB carrier 14, 114, 214, 314 is positioned such that the apertures formed in the PCB are located between the main portion of the light diffuser 10, 110, 210, 310 and the display medium 6, 106, 206, 306. Depending on the shape of the diffuser 10, 110, 210, 310, the light sources 8, 108, 208, 308 may be immediately adjacent or proximate the edge to the PCB as in the embodiment of FIGS. 2 and 3, or well away from the edges as in the other embodiments.

It should be understood that the invention is compatible with the use of other light diffusers, for example a diffuser directly affixed to the light source element optical output facet or lens, or a diffuser screen or paint directly behind or in contact with the display medium 6, 106, 206, 306.

A particular advantage of the invention is that the diffuser base 18, 118, 218, 318 may be an integral part of a rear cover to the display assembly 1. Such covers are often provided with automotive display assemblies in order to protect display components such as a PCB, integrated circuits or other electrical components.

Compared with conventional backlight systems, in which illumination from diffused backlights is directly incident on the display medium, the invention provides good diffusing of light from a reduced number of backlight elements. This is useful when the elements are individual light sources, particularly individual white or colored LEDs.

The invention therefore provides a convenient and economical backlit display.

What is claimed is:

1. A display assembly comprising:
a display unit;
a diffuser disposed adjacent said display unit; and
a light source disposed between said display unit and said diffuser,
wherein said diffuser is adapted to diffuse light rays emitted from said light source in a desired direction to facilitate a backlight illumination of at least a portion of said display unit.

2. The display assembly according to claim 1, wherein said light source is a solid state light source.

3. The display assembly according to claim 2, wherein said light source is a light emitting diode (LED).

4. The display assembly according to claim 2, wherein said light source is a plurality of light emitting diodes (LEDs).

5. The display assembly according to claim 1, wherein said light source is a laser diode.

6. The display assembly according to claim 1, further comprising a carrier, wherein said light source is disposed on said carrier.

7. The display assembly according to claim 6, wherein said carrier is a printed circuit board (PCB) carrier.

8. The display assembly according to claim 6, wherein said carrier includes an aperture formed therein and the light rays from said diffuser are directed through the aperture to provide backlight illumination of said display unit.

9. The display assembly according to claim 6, wherein said carrier includes a diffusive surface.

10. The display assembly according to claim 1, wherein said diffuser has a curvilinear surface.

11. The display assembly according to claim 1, wherein said diffuser has a substantially planar surface substantially parallel to said display unit.

12. The display assembly according to claim 1, wherein said display unit is one of an alphanumeric display, a warning display, a graphical display, a liquid crystal display, and a dial pointer.

13. The display assembly according to claim 1, wherein at least a portion of said diffuser is a rear cover for a display assembly.

14. A display assembly comprising:
a display unit;
a carrier disposed adjacent said display unit;
a light source disposed on said carrier and adapted to be connected to a source of electricity; and
a diffuser disposed adjacent said carrier to interpose said carrier between said display unit and said diffuser, said diffuser adapted to diffuse light rays emitted from said light source in a desired direction to facilitate a backlight illumination of at least a portion if said display unit.

15. The display assembly according to claim 14, wherein said light source is one of a light emitting diode (LED) and a laser diode.

16. The display assembly according to claim 14, wherein said carrier includes a diffusive surface.

17. The display assembly according to claim 14, wherein said diffuser has a substantially planar surface substantially parallel to said display unit.

18. The display assembly according to claim 14, wherein said diffuser has a curvilinear surface.

19. A method of backlighting a display assembly, the method comprising the steps of.
providing a display unit;
providing a diffuser adjacent the display unit;
providing a light source disposed between the display unit and the diffuser;
providing electricity to the light source, wherein said diffuser is adapted to diffuse light rays emitted from said light source in a desired direction to facilitate a backlight illumination of at least a portion of said display unit.

20. The method according to claim 19, wherein said light source is one of a light emitting diode (LED) and a laser diode.
